(19) United States
(12) Patent Application Publication
(10) Pub. No.: US 2008/0055064 A1
(43) Pub. Date: Mar. 6, 2008

(54) Child detector and reminder system

(76) Inventors: John David Keith, Cary, NC (US); Melonie L. Keith, Cary, NC (US)

Correspondence Address: SETO PATENTS, 406 RIVERLAND DR., SALEM, VA, 24153, US

(21) Appl. No.: 11/893,895

(22) Filed: Aug. 20, 2007

Related U.S. Application Data
(60) Provisional application No. 60/842,249, filed on Sep. 5, 2006.

(51) Int. Cl. B60Q 1/00

(52) U.S. Cl. 340/457.1

(57) ABSTRACT

A safety system that reminds parents when their children are still strapped inside the car. The preferred system monitors the status of the driver's seatbelt buckle and the child's buckle, and includes at least two different alarms. The first alarm, which is not offending and can only be heard inside the Vehicle, is sounded after the driver unbuckles and the child remains buckled in the car. The second alarm, which is louder than the first and can be heard outside the vehicle, is sounded after a set amount of time has expired since the driver unbuckled, and yet the child remains buckled in the car. The second alarm is intended to draw the attention of members of the public, and on a hot day could save the child's life.

The present invention was originally disclosed in U.S. provisional patent application Ser. No. 60/842,249 filed on Sep. 5, 2006, and priority is claimed to the provisional patent application.

### BACKGROUND OF THE INVENTION

The present invention relates generally to the field of child safety systems and more specifically to a detection system that prevents children from being left inside an automobile.

Automobile childseats are specially designed seats that securely hold small children while inside an automobile. Traditional childseats, also known as carseats, have at least one strap for holding the child in the seat, and at least one buckle that secures the strap in place. Because the childseat must restrain the child against quick braking and sharp turns, the strap intentionally is secured in a snug position against the child. At the end of the car ride, since young children are not yet familiar with buckles, the child must be unbuckled from the childseat in order for the child to exit the vehicle. Sometimes this fact leads to catastrophic endings.

Hyperthermia is the second leading cause of non-traffic fatalities involving children less than 15 years old. Hyperthermia fatalities typically occur when a parent runs into a store, forgets they brought their child with them, and accidentally leaves the child inside the car, strapped in their childseat. On sunny days, temperatures inside a car quickly reach fatal levels. In spite of this threat to our children, no safety device that reminds parents of any child strapped inside their car, has been made available in the marketplace.

What is needed in the field is a failsafe device that provides graduated reminders to the parent, and eventually to the public, that a child is still strapped in the car.

### SUMMARY OF THE INVENTION

A safety system that is adapted to remind a driver that a child is still in the car, and when necessary, alerts members of the public that the child has been left unattended inside the car. The system comprises a first circuit that indicates when a buckle of the child's seatbelt is buckled, a second circuit that indicates when a buckle of the driver's seatbelt is buckled, and a logic circuit that receives inputs from the first and second circuits. Upon receipt of a specific series of inputs from the first and second circuits, the logic circuit produces a reminder output. A first alarm receives the reminder output from the logic circuit, and in response creates a first audible sound that is able to be heard inside the car. A delay circuit also receives the reminder output from the logic circuit and, after a set amount of time, the delay circuit produces a public alarm output. A second alarm receives the public alarm output, and in response creates a second audible sound that is able to be heard outside of the car. The second alarm is intended to attract the attention of members of the public. Both the first alarm and the second alarm are stopped when the child's seatbelt is unbuckled.

The series of inputs from the first and second circuits that cause the logic circuit to produce the reminder output occur when the child's seatbelt is buckled, the driver's seatbelt is buckled, and then the driver's seatbelt is unbuckled. The first audible sound is preferably a repeating chime that the car is capable of making. The second audible sound is preferably the car's horn honking. The second alarm also preferably includes the car's headlight flashing. The set amount of time in the delay circuit is preferably 3 to 5 minutes. The buckle on the child's seatbelt can be the buckle that is attached to the backseat of the car. The child's buckle may also include a jumper that allows for expansion of the first circuit, wherein the buckle on a childseat that is strapped to the backseat is monitored.

It is an object of the present invention to prevent children from being left inside an unattended vehicle.

It is a further object of the present invention to provide a gentle reminder to a parent, when their child remains strapped inside their car.

It is yet another object of the present invention to provide an alarm that can be heard and seen outside the vehicle, when a child has remained strapped inside the vehicle for a period of time.

It is still yet another objective of the invention to provide a child detector and reminder system that can be retrofit on vehicles or installed in vehicles at the factory.

### BRIEF DESCRIPTION OF THE DRAWINGS

The invention of the present application will now be described in more detail with reference to the accompanying drawings, given only by way of example, in which:

FIG. 1 is a block diagram of the preferred embodiment;

FIG. 2(a) illustrates a vehicle with the present system installed;

FIG. 2(b) illustrates the vehicle after the first alarm has been triggered;

FIG. 2(c) illustrates the vehicle after the second alarm has been triggered;

FIG. 3 shows a childseat that can be connected to the present system; and,

FIG. 4 is a flow chart showing exemplary steps for carrying out the present child detector and reminder system.

### DETAILED DESCRIPTION OF THE INVENTION

The present detector and reminder system provides a gentle reminder to parents, when their child is still strapped in their car. Then, if needed, the system alerts the public to the child that remains strapped inside the car. The present system can help prevent fatalities that occur when a child is forgotten inside a hot car. By taking advantage of hardware, such as the horn, headlights and sound system, that are already on a vehicle, the present system can be added to a vehicle as very low cost. Besides forcing the driver to wear their seatbelt, the preferred embodiment also alerts fire and rescue units when a child is in a car.

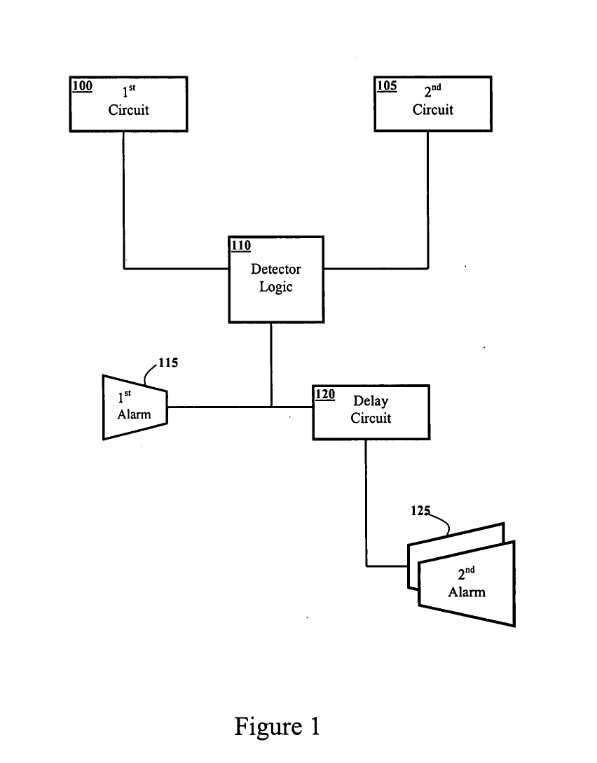

FIG. 1 is a block diagram showing major functional units of the preferred embodiment, which is adapted for connection to a vehicle. The first circuit 100 is connected to a buckle in the backseat of the vehicle that is used to strap-in a child or a childseat. The first circuit 100 uses the buckle as a switch, so that the circuit is able to indicate when the buckle is closed (buckled) and when the buckle is open (unbuckled). The second circuit 105 is connected to the buckle on the driver's seatbelt. The second circuit 105 uses the driver's buckle as a switch, and indicates when the driver's buckle is buckled and unbuckled. The detector logic 110 receives the status of the two buckles from the first and second circuits 100 & 105 and determines whether or not to produce a reminder signal. The detector logic 110 produces a reminder signal when the outputs from the first and second circuits 100 & 105 indicate that the child has been buckled in, the driver was buckled in, and then the driver unbuckled. The detector logic 110 can be produced using either TTL (transistor transistor logic) or CMOS (complementary metal oxide semiconductor) integrated circuits. The reminder signal from the detector logic is received by the first alarm 115 and a delay circuit 120. The first alarm 1 15 is preferably a repeating chime, similar to the one that goes off in many vehicles when the lights are left on. The repeating chime in not loud and offending, and can only be heard inside the vehicle. The delay circuit 120 starts a timer upon receipt of the reminder signal. After 3 to 5 minutes, which can be set by the user, the delay circuit produces an alarm signal that triggers the second alarm 125. The second alarm 125 preferably includes the horn on the vehicle honking and the headlights blinking. The second alarm 125 sounds and flashes an alarm outside the vehicle, so that members of the public are alerted to the potential danger. Both alarms can be shut off by unbuckling the child, and opening the first circuit 100.

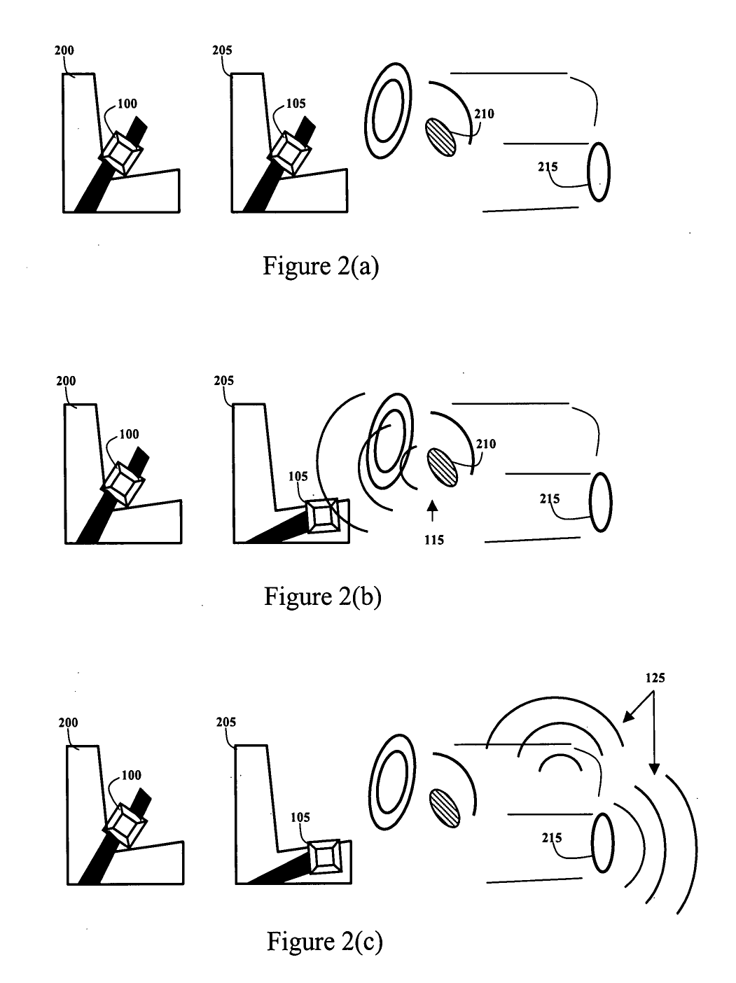

FIG. 2(a) illustrates a vehicle in which the present reminder system has been installed. The figure is intended to illustrate a situation wherein a child, or childseat, has been strapped in the backseat 200 of the vehicle with the aid of the first circuit 100, and the driver is buckled into the front seat 205 with the aid of the second circuit 105. In the dashboard of the vehicle is a speaker 210, and at the front of the vehicle is a headlight 215. In this situation, no alarm is sounded.

FIG. 2(b) continues the situation illustrated in FIG. 2(a). Now, the driver has unbuckled themselves from the front seat 205 of the vehicle, however, the child remains strapped in to the back seat 200 of the vehicle. As a result of this situation, the first alarm 115 in the present system is triggered and a repeating chime is emitted from the speaker 210. The first alarm 115 provides a gentle reminder to the driver that their child remains in the back seat 200.

FIG. 2(c) continues the situation illustrated in the FIG. 2(b). Now, the driver's seatbelt has been unbuckled, leaving circuit 105 open, for more than 3 minutes, and the child's seatbelt has remained buckled the entire time, keeping circuit 100 closed. As a result, the second alarm 125 is triggered. The second alarm 125 includes the vehicle's headlight 215 flashing on and off. The second alarm also preferably include the vehicle's horn honking at a repeating interval. The second alarm will continue until the child is unbuckled from the back seat 200, thus opening circuit 100.

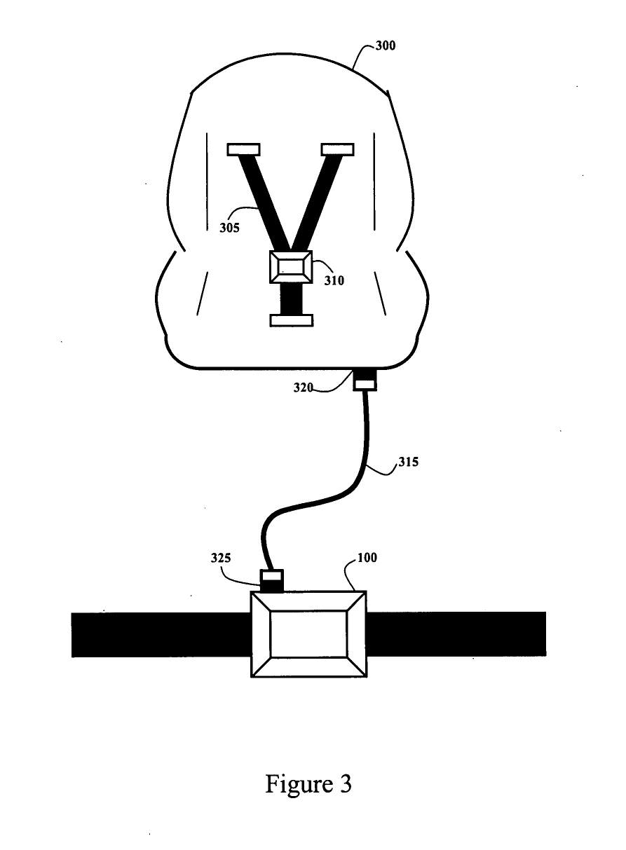

FIG. 3 shows a childseat 300 that can be incorporated into the present system. Some childseats do not use the seatbelt in the back seat to buckle and unbuckle the child. Rather, the seatbelt passes through the back of the childseat and is only used to anchor the childseat to the back seat. A strap within the childseat is then used to buckle and unbuckle the child. In this case, it is the buckle 310 that is in the childseat 300 that the present system monitors. The first circuit 100 can include a jumper 325, or connector, that allows the childseat 300 to be connected to the first circuit, via a cord 315, or cable. The cord 315 connects to the childseat 300 via a second jumper 320 on the childseat. Upon connection to the first circuit 100, the buckle 310 on the childseat acts as the switch in the circuit. Thus, the detection logic is able to monitor the status of a child in the childseat 300.

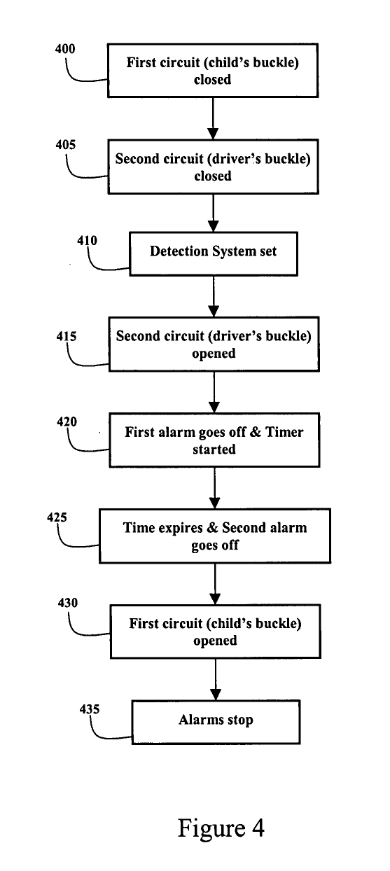

FIG. 4 shows exemplary steps for carrying out the present child detection and reminder system. In step 400, a child is strapped into the car, closing the first circuit. In step 405, the driver buckles into the driver's seat and the second circuit is closed. In step 410, the system notices the closing of the first and second circuits, meaning that the stage has been set for one or more of the system's alarms to go off. In step 415, the driver's buckle is unbuckled and the system generates a reminder signal. In step 420, the reminder signal causes the first alarm to go off, and also starts a timer. The first alarm can be any sound the car is capable of making and is intended to provide a gentle reminder to the driver that a child remains in the back seat. The timer starts a count down to the second alarm. The timer can be set to any time, however, 3 to 5 minutes is preferred. In step 425, time expires in the timer and the second alarm is sounded. The second alarm can include any sound the car is capable of making and any light the car is capable of flashing. The second alarm preferably includes the car's horn honking and the car's headlights flashing. In step 430, either the driver or a member of the public helps the child from the car, unbuckling the child's buckle, and the first circuit is opened. The alarm then stops, step 435.

The foregoing description of the specific embodiments will so fully reveal the general nature of the invention that others can, by applying current knowledge, readily modify and/or adapt for various applications such specific embodiments without departing from the generic concept. For example, the logic and delay circuits could be combined into one module. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A safety system that is adapted to remind a driver that a child is still in a car, and when necessary, alerts members of a public that the child has been left unattended inside the car, the system comprising:
a first circuit that indicates when a buckle of the child's seatbelt is buckled;
a second circuit that indicates when a buckle of the driver's seatbelt is buckled;
a logic circuit that receives inputs from the first and second circuits, wherein, upon receipt of a specific series of inputs from the first and second circuits, the logic circuit produces a reminder output;
a first alarm that receives the reminder output from the logic circuit, and in response creates a first audible sound that is able to be heard inside the car;
a delay circuit that also receives the reminder output from the logic circuit and, after a set amount of time, produces a public alarm output; and, a second alarm that receives the public alarm output from the delay circuit, and in response creates a second audible sound that is able to be heard outside of the car, wherein the second alarm is intended to attract members of the public.

2. The system of claim 1, wherein both the first alarm and the second alarm are stopped when the child's seatbelt is unbuckled.

3. The system of claim 1, wherein the specific series of inputs from the first and second circuits, indicate that the child's seatbelt was buckled, then the driver's seatbelt was buckled, and then the driver's seatbelt was unbuckled.

4. The system of claim 1, wherein the first audible sound is a repeating chime.

5. The system of claim 1, wherein the second audible sound is a honking of a horn.

6. The system of claim 5, wherein the second alarm includes a flashing of at least one light on an exterior of the car.

7. The system of claim 1, wherein the set amount of time in the delay circuit is between 3 and 5 minutes.

8. The system of claim 1, wherein the buckle on the child's seatbelt is attached to a backseat of the car.

9. The system of claim 8, wherein the buckle on the child's seatbelt includes at least one jumper that allows for expansion of the first circuit.

10. The system of claim 1, wherein the buckle on the child's seatbelt is attached to a childseat that is strapped into a backseat of the car.

11. A detection and reminder system that is adapted form attachment to a car, the system being able to remind a driver that a child is still in the car, and when necessary, alert members of a public that the child has been left unattended inside the car, the system comprising:
a first circuit that outputs a high signal when a buckle of the child's seatbelt is buckled;
a second circuit that monitors a status of the driver;
a logic circuit that receives the outputs from the first and second circuits, wherein, upon receipt of a specific series of outputs from the first and second circuits, the logic circuit produces a reminder signal;
a first alarm that receives the reminder signal from the logic circuit, and in response creates a first audible sound that is able to be heard inside the car;
a delay circuit that also receives the reminder signal from the logic circuit and, after a set amount of time, produces a public alarm signal; and, a second alarm that receives the public alarm signal from the delay circuit, and in response creates a second audible sound that is able to be heard outside of the car, wherein the second alarm is intended to attract members of the public.

12. The system of claim 11, wherein both the first alarm and the second alarm are stopped when the child's seatbelt is unbuckled.

13. The system of claim 11, wherein the second circuit monitors a status of the driver's seatbelt.

14. The system of claim 11, wherein the first audible sound is a repeating chime.

15. The system of claim 11, wherein the second audible sound is a honking of the car's horn.

16. The system of claim 15, wherein the second alarm includes a flashing of the car's headlights.

17. The system of claim 11, wherein the set amount of time in the delay circuit is between 3 and 5 minutes.

18. A method for reminding a driver that a child is still strapped in the driver's car, and if the child remains strapped in the car for a period of time, alerting members of a public to the child, the method comprising the steps of:
setting a first alarm when the child's seatbelt is buckled and the driver's seatbelt is buckled;
sounding the first alarm when the driver's seatbelt is unbuckled, wherein the first alarm can be heard inside the car;
setting a second alarm when the first alarm is sounded;
sounding the second alarm after a set amount of time has expired, wherein the second alarm can be heard outside the car.

19. The method of claim 18, wherein the step of sounding the first alarm, further comprises:
using the car's hardware, including at least one speaker, to sound the first alarm.

20. The method of claim 18, where the step of sounding the second alarm, further comprises:
using the car's hardware, including at least one horn, to sound the second alarm.
